(19) United States
(12) Patent Application Publication
(10) Pub. No.: US 2017/0101039 A1
(43) Pub. Date: Apr. 13, 2017

(54) Baby Car Seat and Stroller Protector

(71) Applicant: Rudgie Fadael-Correa, Brooklyn, NY (US)

(72) Inventor: Rudgie Fadael-Correa, Brooklyn, NY (US)

(21) Appl. No.: 15/289,909

(22) Filed: Oct. 10, 2016

Related U.S. Application Data
(60) Provisional application No. 62/239,408, filed on Oct. 9, 2015.

(51) Int. Cl. B60N 2/60; B62B 9/10

(52) U.S. Cl. CPC B60N 2/60; B62B 9/108; B60N 2/6036

(57) ABSTRACT

An infant seat cover apparatus for covering an infant car seat and stroller seat is provided. The infant seat cover apparatus comprises a seat cover having a first layer, a second layer, and a third layer. The seat cover further has an outer perimeter edge. A securing mechanism releasably secures the car seat to the car seat or stroller seat. The seat cover is capable of being positioned over and encompassing the car seat or stroller seat with the third layer contactable with the car seat or stroller seat thereby protecting the car seat or stroller seat from being sullied by foreign materials thus ensuring a clean and sanitary condition.

### CLAIM OF PRIORITY

This patent application claims priority under 35 USC 119 (e) (1) from U.S. Provisional Patent Application Ser. No. 62/239,408 filed Oct. 9, 2015, of common inventorship herewith entitled, “Ant and Land Baby Car Seat and Stroller Protector,” which is incorporated herein by reference as though the same were set forth in its entirety.

### FIELD OF THE INVENTION

The present invention pertains to the field of infant accessories, and more specifically to the field of child and stroller seat covers.

### BACKGROUND OF THE INVENTION

Perhaps one of the most practical and necessary of all infant accessories is a simple car seat. Used from the time of birth through the toddler years and beyond, car seats are extremely useful devices which provide a comfortable and secure place for the child to sit when traveling in the car with Mom or Dad. Most importantly, a car seat is an invaluable safety tool, configured specifically to fully restrain the child in the event of an automobile collision. Using a car seat correctly can mean the difference between life and death for children involved in car accident. Another crucial infant accessory is a baby stroller. As with car seats, these practical devices are utilized to safely and comfortably transport children ranging in age from newborns to toddlers. Providing a comfortable and secure place for the child to sit when strolling through a mall or park with Mom or Dad, strollers eliminate the need for the parent to continuously carry their child and are an invaluable commodity utilized by millions of parents daily.

While there is little dispute over the vast practicality of car seats and strollers, maintaining these devices often is difficult and inconvenient. Because children lack fine motor skills, it is very common for them to drop baby bottles, sippy cups or snack foods that they are enjoying while restrained within their seat. These liquids and solids then spill out on the seat. When this occurs, the surface of the seat is easily sullied by the food product, leaving unsightly stains and sticky residue that must be cleaned for both aesthetic and safety purposes. Infant and toddler children also lack control over their bodily functions, and dealing with leaky diapers and spit up are quite common occurrences for most parents of young children. The residue of this bodily waste tends to leave unsightly stains on a child's seating and spread germs and bacteria that causes illness or infections. Most conscientious parents take careful measures to clean up after these incidents, scrubbing a seat by hand to remove any lingering residue or they endure a complex and difficult task of removing the seat cover from its framework, laundering the cover and then dealing with the intricate fasteners that must be applied to secure it back in place.

The prior art has put forth several designs for child and stroller seat covers. Among these are:

U.S. Pat. No. 7,914,075 to Katie Danziger describes a washable infant car seat cover adapted to removably fit over and onto an infant car seat which includes a safety belt. The cover includes a central part with a central opening for passage of the safety belt and an elastic peripheral edge.

US Patent Publication 2008/0079297 to Tricia T. Braxton Perry describes a seat cover for a child safety seat in the nature of a slipcover that utilizes a multiple ply cover material having a plurality of separated panels extending from a central expanse of cover material. A back panel and a seat panel extend along a central vertical axis, and a pair of wing panels extend laterally therefrom. A plurality of hook and loop fasteners are attached to adjacent, separated panels along opposing panel sides. Restraining safety belts such as are included in five point harness systems are selectively received between adjacent separated panels and are releasably restrained from removal therefrom upon the fastening together of adjacent panels. Upon fastening, the seat cover extends in a substantially continuous manner over a surface of the child safety seat and protects the surface from soilage during use of the safety seat by a child.

U.S. Pat. No. 7,341,011 to Jennifer Bari Pines and Rebecca Coffsky Bernath describes a child car seat cover. This device provides an easily removable, cleanable and adjustable cover for a child car seat that restricts the passage of food, dirt and liquids to the car seat material. The device is comprised of multiple layers of fabric, strap covers, strap openings and strap closures.

U.S. Pat. No. 4,426,113 to Bernard R. Schultz describes a stroller seat with forwardly extending sides, each of which is connected to the frame by a linkage which permits adjustment of the seat position. The cover includes a main portion for lining the interior of the seat. A part extends from the main portion, folds over the seat top, and carries a first pair of laterally extending securing parts, adapted to be situated along the exterior of the respective sides. A second pair of securing parts, laterally extending from the main portion, fold over the respective sides and are releasably connected to the first pair of securing parts to encircle the frame adjacent each side to secure the cover without obscuring the position adjusting linkage or interfering with the operation thereof.

None of these prior art references describe the present invention.

### SUMMARY OF THE INVENTION

It is an object of the present invention to provide a line of protective, waterproof and stain resistant coverings configured specifically to be applied over infant and toddler car seats and stroller seats.

The present invention is a baby car seat and stroller protector in the form of an infant seat cover apparatus for covering an infant car seat and stroller seat. The infant seat cover apparatus comprises a seat cover having a first layer, a second layer, and a third layer. The seat cover further has an outer perimeter edge. A securing mechanism releasably secures the car seat to the car seat or stroller seat. The seat cover is capable of being positioned over and encompassing the car seat or stroller seat with the third layer contactable with the car seat or stroller seat thereby protecting the car seat or stroller seat from being sullied by foreign materials thus ensuring a clean and sanitary condition.

In addition, the present invention includes a method for covering an infant car seat and stroller seat. The method comprises providing a seat cover having a first layer, a second layer, and a third layer, positioning the seat cover over the car seat or stroller, releasably securing the car seat to the car seat or stroller seat, and protecting the car seat or stroller seat from being sullied by foreign materials thus ensuring a clean and sanitary condition.

The present invention further includes an infant seat cover apparatus for covering an infant car seat and stroller seat. The infant seat cover apparatus comprises a seat cover having a cushiony first layer, a foam second layer, and a waterproof third layer. The seat cover further has an outer perimeter edge. A securing mechanism releasably secures the car seat to the car seat or stroller seat. The seat cover is capable of being positioned over and encompassing the car seat or stroller seat with the third layer contactable with the car seat or stroller seat thereby protecting the car seat or stroller seat from being sullied by foreign materials thus ensuring a clean and sanitary condition.

### BRIEF DESCRIPTION OF THE DRAWINGS

FIG. 1 is a front perspective illustrating a seat cover of an infant seat cover apparatus, constructed in accordance with the present invention, with the seat cover mounted on a car seat and having a top velour layer, a middle foam layer, and a bottom waterproof layer.

FIG. 2 is another front perspective view illustrating the seat cover of the infant seat cover apparatus, constructed in accordance with the present invention, with the seat cover constructed from hypoallergenic materials.

FIG. 3 is a rear perspective view illustrating the seat cover of the infant seat cover apparatus, constructed in accordance with the present invention, showing a plurality of securing straps with hook and loop fasteners for securing the seat cover to the car seat or stroller seat.

FIG. 4 is an exaggerated sectional view illustrating the seat cover of the Infant Seat cover apparatus, constructed in accordance with the present invention.

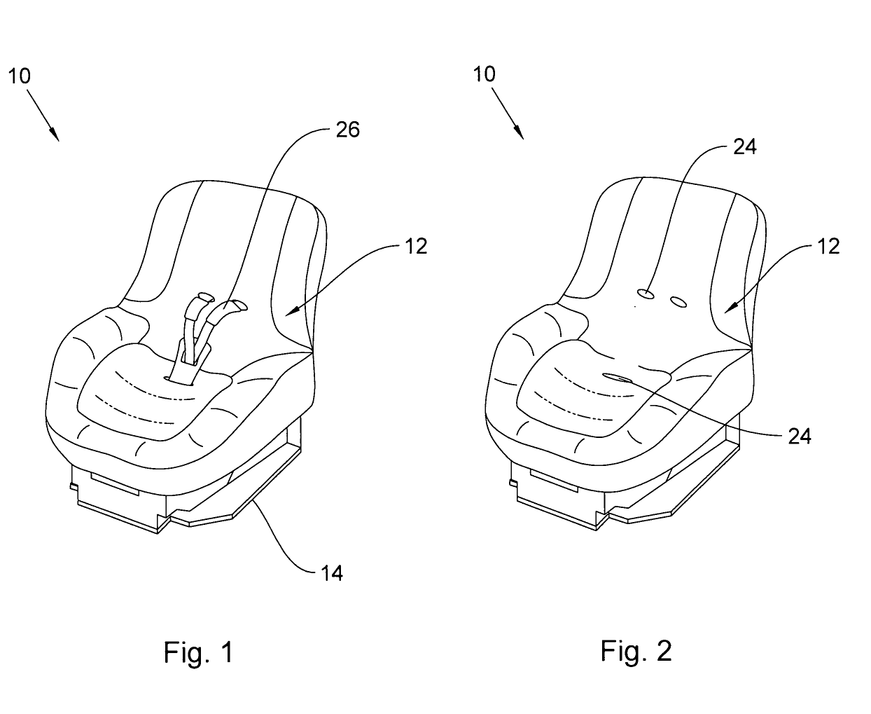

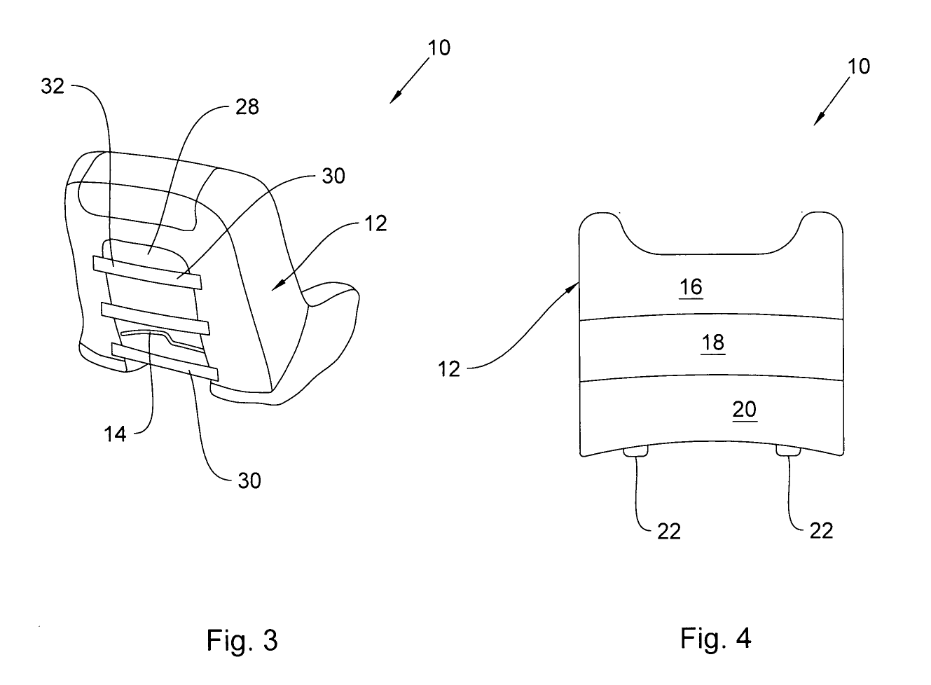

### DETAILED DESCRIPTION OF THE INVENTION

The present invention, hereinafter referred to as the Infant Seat Cover Apparatus, indicated generally at 10, is a line of protective, waterproof, and stain resistant seat covers 12 configured expressly to be applied over infant and toddler car seats 14 and stroller seats. The Infant Seat Cover Apparatus 10 provides parents and caregivers a practical way in which to protect their child's car seat 14 or stroller from being sullied by foods, beverages, bodily fluids, and other matter, thus ensuring a clean and sanitary car seat 14 or stroller seat at all times.

The Infant Seat Cover Apparatus 10 of the present invention includes the seat cover 12 positionable over and encompassing a car seat 14 or stroller seat. The seat cover 12 preferably has a plurality of leak proof, hypoallergenic, and stain resistant fabric layers engineered to facilitate both optimal comfort for the child as well as ease of care for the parent or caregiver. Double stitched and reinforced, the top layer 16, which is the layer that contacts the infant, is preferably comprised of a cushiony soft and breathable velour type material. The top layer 16 preferably has thermal properties keeping the surface of the cover cool during warm summer months and warm during the cold days of winter. Positioned directly below the top layer 16 is a middle layer 18 of soft, high quality, dense foam providing gentle cushioning to the child during transport in their car seat or stroller. The bottom layer 20, which abuts flush against the existing car seat 14 or stroller seat, is comprised of leak resistant, waterproof fabric material that effectively prevents moisture from seeping through the seat cover 12 to the actual car seat 14 or stroller seat.

In addition, the seat cover 12 of the Infant Seat Cover Apparatus 10 of the present invention includes hook and loop or other type fasteners 22 positioned on the bottom layer of the seat cover that correspond to hook and loop fasteners on the car seat 14 or stroller. To releasably secure the car seat cover 12 to the car seat 14 or stroller seat, the user matches corresponding fasteners 22 and mates the fasteners 22 together.

The seat cover 12 of the Infant Seat Cover Apparatus 10 of the present invention additionally includes a plurality of apertures 24 for receiving the seat harness accessories 26 of the car seat 14 or stroller seat. Preferably, the apertures 26 are positioned in the appropriate positions for the intended car seat 14 or stroller seat. Also, preferably, the apertures 26 extend completely through all three layers 16, 18, 20 of the seat cover 12.

Further, the seat cover 12 of the Infant Seat Cover Apparatus 10 of the present invention has an outer perimeter edge 28 and is form fitted to easily slide over an existing car seat 14 or stroller. The seat cover 12 is preferably constructed in sizes appropriate to accommodate standard cradle style, bucket, and upright car seats 14, as well as various types of strollers including portable, jogging, and standard stroller designs. Machine washable, the seat cover 12 can be manufactured in a wide range of vibrant colors, charming patterns and printed designs.

The Infant Seat Cover Apparatus 10 of the present invention further includes a plurality of straps 30 affixed to the outer perimeter edge 28 of the seat cover 12. In a preferred embodiment, the straps 30 are constructed from an elastic material facilitating a secure and customized fit eliminating gaps when applied although constructing the straps 30 from a non-elastic material is within the scope of the present invention.

In addition to or alternatively to the hook and loop fasteners 22 positioned on the bottom layer 20 of the seat cover 12 that correspond to hook and loop fasteners on the car seat 14 or stroller, the seat cover 12 of the Infant Seat Cover Apparatus 10 of the present invention can be releasably secured to the car seat 14 or stroller by the affixing straps 30 wrapped about the car seat 14 or stroller. Preferably, each of the affixing straps 30 have corresponding fasteners 32 to releasably secure the seat cover 12 to the car seat 14 or stroller. In a preferred embodiment, the fasteners 32 are hook and loop fasteners although any type of fastener 32 including, but not limited to, snaps, buckles, buttons, etc., are within the scope of the present invention. It should be noted that the fasteners 32 can be used with elastic straps or non-elastic straps, depending on the desires of the user.

Use of the Infant Seat Cover Apparatus 10 of the present invention is very simple and straightforward. A user purchases one or more seat covers 12 in sizes appropriate to accommodate their child's car seat 14 and stroller seat. Application of the seat cover 12 involves positioning the seat cover 12 directly over an existing seat cushion 14 and adjusting the seat cover 12 via the affixing straps 30 so that it completely encompasses the top of the infant seat 14 or stroller including the seat cushion, back rest, and head rest. The user then secures the form fitting seat cover 12 in place by means of hook and loop fasteners 32 located on the affixing straps 30, threading the straps 30 through the existing seat belting or harnesses to facilitate quick removal as needed.

In the event a child has an accident within their car seat 14 or stroller, whether spilling a beverage or experiencing a leaky diaper, the Infant Seat Cover Apparatus provides a reliable barrier between the liquid or solid matter and the actual seat itself. The parent wipes the seat cover 12 clean or, if necessary, easily slips the seat cover 12 off the car seat 14 and tosses it in the household washer and dryer for easy clean up. The fresh and sanitary car seat cover 12 is then effortlessly reapplied to the car seat 14 or stroller seat. Durably constructed of high quality material, the seat cover 12 will withstand years of repeated use with ease.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An infant seat cover apparatus for covering an infant car seat and stroller seat, the infant seat cover apparatus comprising:
a seat cover having a first layer, a second layer, and a third layer, the seat cover further having an outer perimeter edge; and
securing means for releasably securing the car seat to the car seat or stroller seat;
wherein the seat cover is capable of being positioned over and encompassing the car seat or stroller seat, the third layer contactable with the car seat or stroller seat, thereby protecting the car seat or stroller seat from being sullied by foreign materials thus ensuring a clean and sanitary condition.

2. The infant seat cover apparatus of claim 1 wherein the first layer is constructed from a cushiony soft and breathable velour type material.

3. The infant seat cover apparatus of claim 2 wherein the second layer is positioned directly against the first layer and is constructed from a dense foam material.

4. The infant seat cover apparatus of claim 3 wherein the third layer is constructed of a leak resistant, waterproof fabric material.

5. The infant seat cover apparatus of claim 1 and further comprising:
a plurality of apertures formed completely through the seat cover.

6. The infant seat cover apparatus of claim 1 wherein the securing means is a plurality of hook and loop fasteners positioned on the third layer of the seat cover that correspond to hook and loop fasteners on the car seat.

7. The infant seat cover apparatus of claim 1 wherein the securing means is a plurality of straps affixed to the outer perimeter edge of the seat cover.

8. The infant seat cover apparatus of claim 7 wherein the straps are constructed from an elastic material.

9. The infant seat cover apparatus of claim 7 and further comprising:
at least one fastener associated with each strap for releasably securing the seat cover to the car seat.

10. A method for covering an infant car seat and stroller seat, the method comprising:
providing a seat cover having a first layer, a second layer, and a third layer;
positioning the seat cover over the car seat or stroller;
releasably securing the car seat to the car seat or stroller seat; and
protecting the car seat or stroller seat from being sullied by foreign materials thus ensuring a clean and sanitary condition.

11. An infant seat cover apparatus for covering an infant car seat and stroller seat, the infant seat cover apparatus comprising:
a seat cover having a cushiony first layer, a foam second layer, and a waterproof third layer, the seat cover further having an outer perimeter edge; and
securing means for releasably securing the car seat to the car seat or stroller seat;
wherein the seat cover is capable of being positioned over and encompassing the car seat or stroller seat, the third layer contactable with the car seat or stroller seat, thereby protecting the car seat or stroller seat from being sullied by foreign materials thus ensuring a clean and sanitary condition.

12. The infant seat cover apparatus of claim 11 and further comprising:
a plurality of apertures formed completely through the seat cover.

13. The infant seat cover apparatus of claim 11 wherein the securing means is a plurality of hook and loop fasteners positioned on the third layer of the seat cover that correspond to hook and loop fasteners on the car seat.

14. The infant seat cover apparatus of claim 11 wherein the securing means is a plurality of straps affixed to the outer perimeter edge of the seat cover.

15. The infant seat cover apparatus of claim 14 wherein the straps are constructed from an elastic material.

16. The infant seat cover apparatus of claim 14 and further comprising:
at least one fastener associated with each strap for releasably securing the seat cover to the car seat.
